(19) United States
(12) Patent Application Publication
(10) Pub. No.: US 2025/0209135 A1
(43) Pub. Date: Jun. 26, 2025

(54) ALGORITHMS FOR SPARSE ATTENTION OPERATIONS

(71) Applicant: Industrial Technology Research Institute, Hsinchu (TW)

(72) Inventors: Yao-Hua Chen, Taoyuan City (TW); Chih-Tsun Huang, Hsinchu City (TW); Yu-Sung Lee, Kaohsiung City (TW); Po-Hung Lin, Hsinchu City (TW)

(73) Assignee: Industrial Technology Research Institute, Hsinchu (TW)

(21) Appl. No.: 18/951,676

(22) Filed: Nov. 19, 2024

(30) Foreign Application Priority Data
Dec. 20, 2023 (TW) 112149616

(51) Int. Cl. G06F 17/16; G06N 3/082

(52) U.S. Cl. CPC G06F 17/16; G06N 3/082

(57) ABSTRACT

An algorithm for a sparse attention operation is provided, and the algorithm includes following steps. An attention probability matrix is calculated based on a query matrix and a key matrix. A pruning ratio is calculated based on the attention probability matrix. The attention probability matrix is pruned based on the pruning ratio to obtain a pruned attention probability matrix. A value matrix is pruned based on the pruning ratio to obtain a pruned value matrix. The pruned attention probability matrix and the pruned value matrix are multiplied to obtain an attention matrix.

### CROSS-REFERENCE TO RELATED APPLICATION

This application claims the priority benefit of Taiwan application serial no. 112149616, filed on Dec. 20, 2023. The entirety of the above-mentioned patent application is hereby incorporated by reference herein and made a part of this specification.

### TECHNICAL FIELD

The disclosure relates to algorithms for sparse attention operations.

### BACKGROUND

As applications in natural language processing and other fields continue to grow, the utilization of models employing transformers is also on the rise. The models require considerable computational resources and necessitate high performance when handling extensive data or conducting real-time calculations. Hence, algorithms capable of preserving model performance while mitigating computational costs possess significant application value.

### SUMMARY

One or more exemplary embodiments of the disclosure provide an algorithm for a sparse attention operation to reduce the computational load of models while maintaining model accuracy.

One of the exemplary embodiments provides an algorithm for a sparse attention operation. The algorithm includes following steps. An attention probability matrix is calculated, by a processor, based on a query matrix and a key matrix stored in a storage device. A pruning ratio is calculated, by the processor, based on the attention probability matrix. The attention probability matrix is pruned, by the processor, based on the pruning ratio to obtain a pruned attention probability matrix. A value matrix generated by an input text is pruned, by the processor, based on the pruning ratio to obtain a pruned value matrix. The pruned attention probability matrix and the pruned value matrix are multiplied, by the processor, to obtain an attention matrix.

Another of the exemplary embodiments provides an algorithm for a sparse attention operation, and the algorithm includes following steps. A query matrix stored in a storage device is pruned, by a processor, based on a first pruning ratio stored in the storage device to obtain a pruned query matrix, where the first pruning ratio is a pruning ratio of a previous pruned layer. A key matrix stored in the storage device is pruned, by the processor, based on the first pruning ratio to obtain a pruned key matrix. An attention probability matrix is calculated, by the processor, based on the pruned query matrix and the pruned key matrix. A second pruning ratio is calculated, by the processor, based on the attention probability matrix. The attention probability matrix is pruned, by the processor, based on the second pruning ratio to obtain a pruned attention probability matrix. A value matrix generated by the input text is pruned, by the processor, based on the second pruning ratio to obtain a pruned value matrix. The pruned attention probability matrix and the pruned value matrix are multiplied, by the processor, to obtain an attention matrix.

Based on the above, according to one or more embodiments of disclosure, the needs of real-time calculations may be satisfied, energy efficiency may be improved, the trend of mobile device operations may be adapted, and the development of relevant research may be promoted. One or more embodiments of disclosure provides a dynamic pruning strategy that dynamically adjusts the pruning ratio according to the characteristics of the input text to reduce the amount of data involved in the calculations. Compared with conventional static token pruning algorithms, the algorithms provided in one or more embodiments of disclosure exhibit higher flexibility and adaptability. Experiments have proven that the algorithms provided herein may maintain model performance while reducing computational costs, and the algorithms outperform the conventional static pruning algorithms in most scenarios. In addition, one or more embodiments of disclosure further provides a token selection criterion based on an element-wise square of attention probability to better preserve the semantic information of the input text. In summary, one or more embodiments of disclosure provides an efficient dynamic pruning strategy which may be extensively applied for accelerating and optimizing transformer-based models.

In order to make the features and advantages of the disclosure more comprehensible, the following specific embodiments are described in detail in connection with accompanying drawings.

### BRIEF DESCRIPTION OF THE DRAWINGS

The accompanying drawings are included to provide a further understanding of the disclosure, and the accompanying drawings are incorporated in and constitute a part of this specification. The drawings illustrate the exemplary embodiments of the disclosure, and together with the description, serve to explain the principle of the disclosure.

FIG. 1 is a flowchart of an algorithm according to some embodiments of the disclosure.

FIG. 2 is a flowchart of an algorithm according to some embodiments of the disclosure.

FIG. 3A is an attention probability matrix of an algorithm according to the related art.

FIG. 3B is an attention probability weighted matrix of an algorithm according to some embodiments of the disclosure.

FIG. 4A illustrates a result obtained after the attention probability matrix depicted in FIG. 3A is pruned.

FIG. 4B illustrates a result obtained after the attention probability weighted matrix depicted in FIG. 3B is pruned.

FIG. 5 illustrates a comparison of an algorithm provided in the related art and an algorithm according to some embodiments of the disclosure.

FIG. 6 is a schematic diagram of a system for performing the algorithm according to some embodiments of the disclosure.

### DETAILED DESCRIPTION OF DISCLOSURED EMBODIMENTS

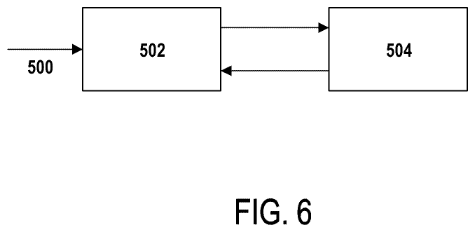

FIG. 6 is a schematic diagram of a system for performing the algorithm according to some embodiments of the disclosure. An input text 500 is input to the storage device 502, and is then transmitted to the processor 504 and being processed. In some embodiments, the intput text 500 may be a sentence, a paragraph, or an article, which is not limited thereto. In some embodiments, the storage device 502 may be a flash drive, a memory card, a solid state drive (SSD) or wireless memory storage device, which is not limited thereto. In some embodiments, the processor 504 may be, for example, a microcontroller unit (MCU), a central processing unit (CPU), a microcontroller (microprocessor), a digital signal processor (DSP), a programmable The present invention is not limited to a processor, a programmable logic device (PLD) or other similar devices or a combination of these devices. Furthermore, in one embodiment, each function of the processor 150 may be implemented as multiple program codes. These program codes will be stored in a memory, such as the storage device 502, and the processor 504 will execute these program codes. Alternatively, in one embodiment, the functions of processor 504 may be implemented as one or more circuits. The present invention is not limited to using software or hardware to implement each function of the processor 504.

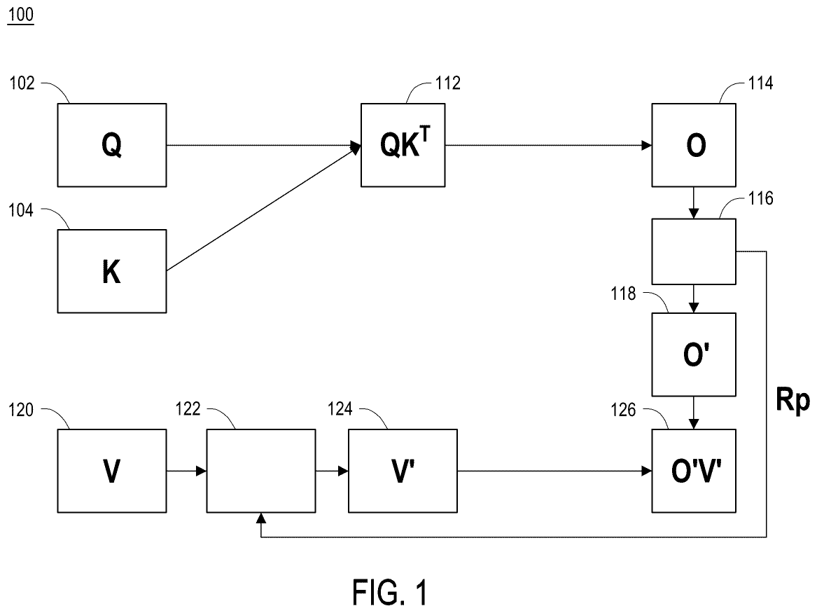

FIG. 1 is a flowchart of an algorithm according to some embodiments of the disclosure. Please refer to FIG. 1 and FIG. 6. With reference to FIG. 1, a flowchart 100 illustrates an algorithm for a sparse attention operation. The algorithm has three input matrices, namely a query matrix 102, also referred to as a Q matrix 102; a key matrix 104, also referred to as a K matrix 104; and the value matrix 120, also referred to as a V matrix 120.

The query matrix 102, the key matrix 104, and the value matrix 120 are all M*N matrices with M rows and N columns. Here, the number of rows M is the number n of tokens in an input text, and the number of columns N is the number of dimensions of the model, denoted as d_{model}.

The algorithm includes following steps.

Step 1: calculating, by the processor 504, an attention probability matrix 114 based on the query matrix 102 and the key matrix 104 stored in the storage device 502.

Specifically, transpose matrices of the query matrix 102 and the key matrix 104 are multiplied to obtain a matrix 112. The matrix 112 may be represented as QKT, which is an M*M matrix.

A softmax operation is then performed on each element of the matrix 112 to obtain the attention probability matrix 114. The softmax function, also known as a normalized exponential function, serves to ensure that each element in each row of the attention probability matrix 114 has the value between 0 and 1, and the sum of the values of the elements in each row is 1. The higher the values of the elements, the higher the probability (attention).

Therefore, the query matrix 102, the key matrix 104, and the attention probability matrix 114 satisfy the following relationship:

$$O = softmax ( \frac{Q {K}^{T}}{\sqrt{{d}_{k}}} ) ,$$

where dₖ is the number of columns in the key matrix.

Step 2: inputting the attention probability matrix 114 into an operation 116 to calculate a pruning ratio R_{P} by the processor 504. Specific steps of the operation 116 are described as follows.

Each element of the attention probability matrix 114 is weighted to obtain an M*M attention probability weighted matrix.

Specifically, in the step of weighting each element of the attention probability matrix 114, after weighting, a difference between the maximum value and the minimum value of the elements in the attention probability matrix 114 may be amplified for filtering out the elements with relatively large weights. Therefore, in this step, if the maximum value of the elements in the attention probability matrix 114 is Vmax, the minimum value of the elements in the attention probability matrix 114 is Vmin, the weighted maximum value Vmax obtained after weighting is Vmax′, and the weighted minimum value Vmin obtained after weighting is Vmin′, then the following relationship is satisfied:

$$\frac{V max}{V min} \leq \frac{V max ′}{V min ′} .$$

Here, the equal sign asserts all elements have the equal value. In this case, all elements have the same weight, and pruning cannot be performed.

Specifically, in the step of weighting each element of the attention probability matrix 114, a function may be selected according to actual needs to weight the values of the elements of the attention probability matrix 114. In some embodiments, each element is weighted by applying a non-linear method. In some embodiments, the non-linear method includes calculating the square value of each element or any other suitable method.

Explanations are provided below with reference to examples. Table 1 shows the attention probability matrix 114 according to an embodiment of the disclosure, and the attention probability matrix 114 is a 6×6 matrix.

TABLE 1

| | | | | | | Sum |
|---|---|---|---|---|---|---|
| ⅙ | ⅙ | ⅙ | ⅙ | ⅙ | ⅙ | 1 |
| 1/12 | 1/12 | 1/12 | 1/12 | 1/12 | 7/12 | 1 |
| 1/24 | 1/24 | 1/24 | 1/24 | 1/24 | 19/24 | 1 |
| 1/24 | 1/24 | 1/24 | 1/24 | 1/24 | 19/24 | 1 |
| 1/24 | 1/24 | 1/24 | 1/24 | 1/24 | 19/24 | 1 |
| 1/24 | 1/24 | 1/24 | 1/24 | 1/24 | 19/24 | 1 |

As shown in Table 1, the sum of the elements in each row of the matrix in Table 1 is 1, which indicates that the probability sum of each row is 1.

On the other hand, in the first row of Table 1, the values of all elements are 1/6, indicating that the probabilities or attentions of each element are equal, i.e., each element has the same importance. In the second row, the values of the first five elements are all 1/12, and the value of the sixth element is 7/12; namely, the probability or attention of the sixth element is greater than the probabilities or attentions of the first five elements. In the third row, the values of the first five elements are all 1/24, and the value of the sixth element is 19/24; namely, the probability or attention of the sixth element is greater than the probabilities or attentions of the first five elements, and compared with the second row, the proportion of the sixth element is higher, indicating that the importance of the sixth element is greater.

The square value of each element in Table 1 is calculated to weight each element, and results are shown in Table 2. Table 2 is also known as an attention probability weighted matrix or an attention probability square matrix.

TABLE 2

| | | | | | |
|---|---|---|---|---|---|
| 1/36 | 1/36 | 1/36 | 1/36 | 1/36 | 1/36 |
| 1/144 | 1/144 | 1/144 | 1/144 | 1/144 | 49/144 |
| 1/576 | 1/576 | 1/576 | 1/576 | 1/576 | 381/576 |
| 1/576 | 1/576 | 1/576 | 1/576 | 1/576 | 381/576 |
| 1/576 | 1/576 | 1/576 | 1/576 | 1/576 | 381/576 |
| 1/576 | 1/576 | 1/576 | 1/576 | 1/576 | 381/576 |

As shown in Table 2, in the first row of Table 2, the values of all the elements are 1/36. That is, when each probability is equal before weighting (Table 1), the relative values remain unchanged after weighting; that is, each element has the same importance.

In the second row, the values of the first five elements are all 1/144, and the value of the sixth element is 49/144; namely, the probability or attention of the sixth element is greater than the probabilities or attentions of the first five elements. Specifically, before weighting, a ratio of the maximum value 7/12 of the elements in the second row to the minimum value 1/12 of the elements in the second row is 7, and after weighting, the ratio of the maximum value 49/144 of the elements in the second row to the minimum value 1/144 of the elements in the second row is 49, which is greater than the ratio before weighting. It may therefore be derived from the above that the elements with greater attention (the maximum value of the elements) may be highlighted after weighting.

In the third row, the values of the first five elements are all 1/576, and the value of the sixth element is 361/576; that is, the probability or attention of the sixth element is greater than the probabilities or attentions of the first five elements. Specifically, before weighting, the ratio of the maximum value 19/24 of the elements in the second row to the minimum value 1/24 of the elements in the second row is 19, and after weighting, the ratio of the maximum value 361/576 of the elements in the second row to the minimum value 1/576 of the elements in the second row is 361, which is much greater than the ratio before weighting. It may therefore be derived from the above that the elements with greater attention (the maximum value of the elements) may be highlighted after weighting.

Next, the sum of the elements in each row of the attention probability weighted matrix (as shown in Table 2) is calculated to obtain a row weighted sum of each row of the attention probability weighted matrix. In addition, the sum of the elements in each column of the attention probability weighted matrix is calculated to obtain a column weighted sum of each column of the attention probability weighted matrix, as shown in Table 3.

sum

TABLE 3

| | | | | | | | sum |
|---|---|---|---|---|---|---|---|
| | 1/36 | 1/36 | 1/36 | 1/36 | 1/36 | 1/36 | 6/36 |
| | 1/144 | 1/144 | 1/144 | 1/144 | 1/144 | 49/144 | 54/144 |
| | 1/576 | 1/576 | 1/576 | 1/576 | 1/576 | 381/576 | 366/576 |
| | 1/576 | 1/576 | 1/576 | 1/576 | 1/576 | 381/576 | 366/576 |
| | 1/576 | 1/576 | 1/576 | 1/576 | 1/576 | 381/576 | 366/576 |
| | 1/576 | 1/576 | 1/576 | 1/576 | 1/576 | 381/576 | 366/576 |
| sum | 24/576 | 24/576 | 24/576 | 24/576 | 24/576 | 1656/576 | |

With reference to Table 3, when the sum of the elements in each row of the attention probability weighted matrix (as shown in Table 2) is calculated to obtain the row weighted sum of each row of the attention probability weighted matrix, the row weighted sum of each row may serve to represent the probability distribution in each row. The smaller the row weighted sum, the more even the probability distribution in that row. On the other hand, the larger the row weighted sum, the more uneven the probability distribution in that row. Therefore, taking the first, second, and third rows in Table 3 as examples, the row weighted sums of the first three rows are 6/36, 54/144, and 366/576, respectively. The relative order is 6/36<54/144<366/576, indicating that the distribution in the third row is relatively uneven compared to the distributions in the first and second rows.

On the other hand, when the sum of the elements of each column of the attention probability weighted matrix (as shown in Table 2) is calculated to obtain the column weighted sum of each column of the attention probability weighted matrix, the column weighted sum of each column is referred to as the importance score of each column, which may serve to represent the importance of each column. The higher the column weighted sum, the higher the importance of the corresponding column, and the lower the column weighted sum, the lower the importance of the corresponding column. The lower the importance score, the higher the chance that the corresponding column is pruned during pruning.

With reference to Table 3, the row weighted sum of each row of the attention probability weighted matrix (e.g., Table 3) is accumulated to obtain attention information of the attention probability weighted matrix. As shown in Table 3, the row weighted sum of each row is accumulated to obtain 1776/576=3.083. In some embodiments, the attention information is referred to as sparsity and serves to measure the degree of dispersion in the attention probability weighted matrix.

Finally, a pruning ratio R_{P} is determined based on the attention information. Specifically, the attention information is normalized within a range to obtain the pruning ratio. The range is defined by the upper limit and the lower limit of the attention information.

For instance, when the number of tokens is n, in one extreme scenario, if the probabilities of all the tokens are evenly distributed, then the probability of each token is 1/n. If the attention information (i.e., sparsity) is calculated after each probability is weighted by

$$S = \frac{1}{{n}^{2}} \times n \times n = 1$$

applying a square method, the attention information may be obtained. In another extreme scenario, if the probability of one token is 1, and the probabilities of all other tokens are 0, then the attention information S=1×n=n may be obtained.

Therefore, based on the above calculations, it is known that when the square method is applied for weighting, if the number of the tokens is n, the upper and lower limits 1≤S≤n of the sparsity S may be obtained.

Normalizing the attention information includes: normalizing the attention information in a linear manner or a non-linear manner. For instance, as previously mentioned, if the square method is applied for weighting, the upper and lower limits 1≤S≤n of the sparsity S may be obtained, i.e., the sparsity S is between 1 and n. Therefore, the pruning ratio may be expressed by the following formula:

$${R}_{P} = α \frac{{s}_{I - 1}}{n - 1} ,$$

where R_{P} is the pruning ratio, α is the given parameter, S₁ is the attention parameter, and n is the number of the tokens in the attention probability matrix.

Step 3: pruning, by the processor 504, the attention probability matrix 114 according to the pruning ratio R_{P} to obtain a pruned attention probability matrix 118. Specifically, this step includes: calculating the number of column prunings based on the pruning ratio R_{P} and the number of columns in the attention probability matrix 114, where the number of column prunings is less than or equal to the maximum integer of the product obtained by multiplying the pruning ratio and the number of columns in the attention probability matrix 114 and is the number of columns required to be pruned in the attention probability matrix 114.

Subsequently, the column weighted sum of each column of the attention probability matrix 114 is arranged in an ascending order, and the columns corresponding to the column weighted sums are pruned in an ascending order until the number of the pruned columns equals the number of column prunings, so as to obtain the pruned attention probability matrix 118. Here, pruning a row means setting the values of all the elements in the columns to 0.

Therefore, after pruning, the size of the obtained pruned attention probability matrix 118 is the same as the original matrix, i.e., the attention probability matrix 114, but the values of the elements in the pruned rows are all 0, whereby the computational load may be significantly reduced during matrix operations.

Step 4: in an operation 122, the value matrix 120, generated by an input text 500, is pruned, by the processor 504, according to the pruning ratio to obtain a pruned value matrix 124. Specifically, the value matrix 120 is pruned in step 4 in the same manner as the operation 116 in step 2, and the difference therebetween lies in that in the value matrix 120 only the corresponding column weighted sums are calculated, and the value matrix 120 is pruned according to the pruning ratio R_{P} obtained in the operation 116 in a similar way to the operation 116, so as to obtain the pruned value matrix 124.

Step 5: multiplying, by the processor 504, the pruned attention probability matrix 118 by and pruned value matrix 124 to obtain an attention matrix 126.

Hence, according to the algorithm shown in FIG. 1, the tokens corresponding to the input text may be calculated and pruned according to the input text, thus significantly reducing the computational load during matrix operations.

In the algorithm shown in FIG. 1, there is only one pruned layer. If there are a plurality of pruned layers, starting from the second pruned layer, the pruning ratio obtained from the previous pruned layer may be applied to prune the query matrix and key matrix in advance to reduce the computational load.

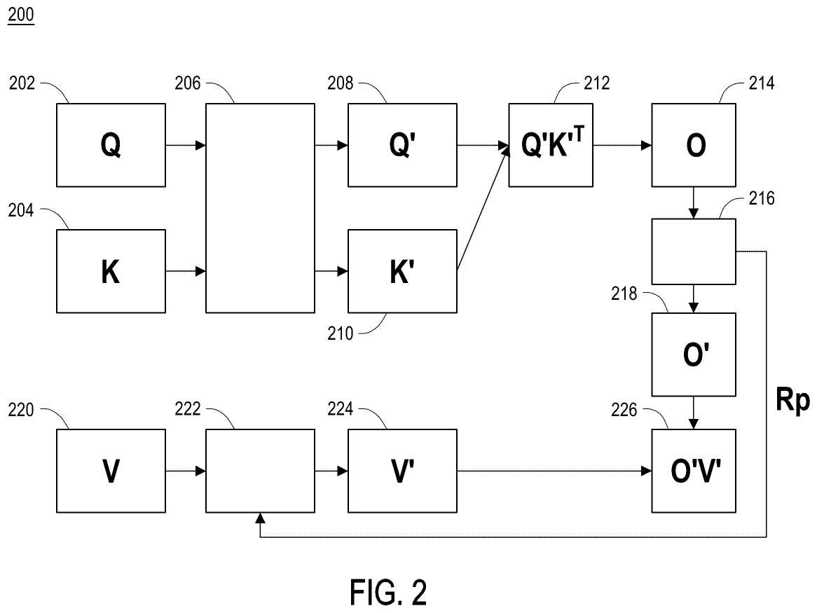

FIG. 2 is a flowchart of an algorithm according to some embodiments of the disclosure. With reference to FIG. 2, the algorithm shown in FIG. 2 is similar to the algorithm shown in FIG. 1, and thus some steps in FIG. 2 are similar to those in FIG. 1

Similar to the algorithm in FIG. 1, the algorithm in FIG. 2 has three input matrices, i.e., a query matrix 202, also referred to as a Q matrix 202; a key matrix 204, also referred to as a K matrix 104, and a value matrix 220, also referred to as a V matrix 220. The query matrix 202, the key matrix 204, and the value matrix 220 are all M*N matrices with M rows and N columns. Here, the number of the rows M is the number n of tokens in the input text, and the number of the columns N is the number of dimensions of the model, denoted as d_{model}.

Step 1: pruning, by the processor 504, the query matrix 202, stored in the storage device 502, in the algorithm 206 according to a first pruning ratio, stored in the storage device 502, to obtain a pruned query matrix 208, where the first pruning ratio is a pruning ratio of the previous pruned layer. The key matrix 204, sorted in the storage device 502, is pruned, by the processor 504, according to the first pruning ratio to obtain a pruned key matrix 210.

Specifically, the first pruning ratio here is the pruning ratio calculated in the previous pruned layer. Generally, in different pruned layers, the query matrix 202 and the key matrix 204 are similar to the query matrix and the key matrix of the previous layer, so the pruning ratio calculated in the previous pruned layer may be applied to prune the query matrix 202 and the key matrix 204 in advance, so as to obtain the pruned query matrix 208 and the pruned key matrix 210. The pruning method is similar to what is provided in the operation 116 in FIG. 1 and will not be further elaborated hereinafter.

Step 2: calculating, by the processor 504, an attention probability matrix 214 based on the pruned query matrix 208 and the pruned key matrix 210. In comparison, FIG. 1 illustrates the attention probability matrix that is calculated by applying the unpruned query matrix 102 and the unpruned key matrix 104, while FIG. 2 illustrates the attention probability matrix 214 that is calculated by applying the pruned query matrix 208 and the pruned key matrix 210. Therefore, in FIG. 2, the computational load for calculating the attention probability matrix 214 is less than the computational load for calculating the attention probability matrix 114 in FIG. 1.

Step 3: inputting the attention probability matrix 214 into an operation 216 to calculate, by the processor 504, a second pruning ratio R_{P}. The specific steps of the operation 216 are similar to the steps of the operation 116 in FIG. 1 and thus will not be further elaborated hereinafter.

Step 4: pruning, by the processor 504, the attention probability matrix 214 based on the second pruning ratio R_{P} to obtain a pruned attention probability matrix 218. The specific steps of calculating the pruned attention probability matrix 218 are similar to the steps of calculating the pruned attention probability matrix 118 in FIG. 1 and thus will not be further elaborated hereinafter.

Step 5: in an operation 222, pruning, by the processor 504, a value matrix 220, generated by the input text 500, based on the second pruning ratio R_{P} to obtain a pruned value matrix 224. The specific steps for calculating the pruned value matrix 224 are similar to the steps in the operation 122 in FIG. 1 and thus will not be further elaborated hereinafter. The pruning ratio applied herein for pruning the value matrix 220 is the second pruning ratio R_{P} obtained in the operation 216 in the pruned layer.

Step 6: multiplying, by the processor 504, the pruned attention probability matrix 218 and the pruned value matrix 224 to obtain the attention matrix 126.

Hence, according to the algorithm shown in FIG. 2, the tokens corresponding to the input text may be calculated and pruned according to the input text. Specifically, the query matrix 202 and the key matrix 204 may be pruned in advance based on the pruning ratio calculated in the previous pruned layer, which may significantly reduce the computational load of calculating the attention probability matrix 214 and reduce the computational load during subsequent matrix operations.

Explanations are provided below with reference to examples and comparison with the related art.

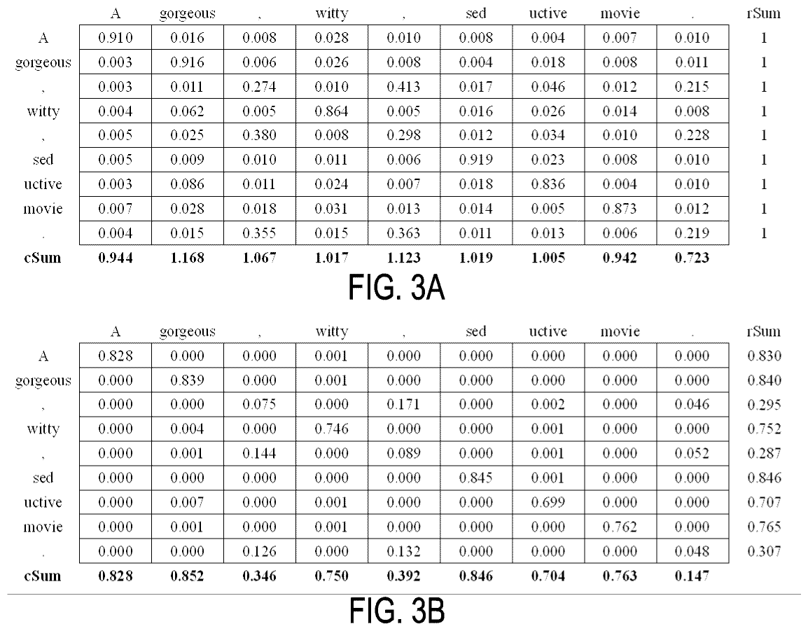

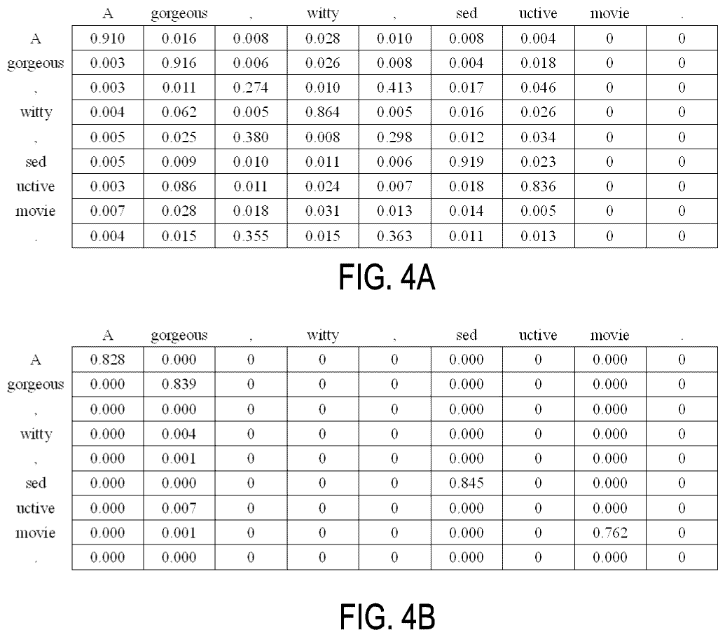

FIG. 3A is an attention probability matrix of an algorithm according to the related art. FIG. 3B is an attention probability weighted matrix of an algorithm according to some embodiments of the disclosure. FIG. 4A illustrates a result obtained after the attention probability matrix depicted in FIG. 3A is pruned. FIG. 4B illustrates a result obtained after the attention probability weighted matrix depicted in FIG. 3B is pruned.

With reference to FIG. 3A and FIG. 3B, in this embodiment, both the algorithm provided in the related art and the algorithm provided in the disclosure include operations on the same text “A gorgeous, witty, seductive movie.” This text is divided into 9 tokens, which are “A”, “gorgeous”, “,”, “witty”, “,”, “sed”, “uctive”, “movie”, “.”.

FIG. 3A is an attention probability matrix of an algorithm according to the related art. FIG. 3B is an attention probability weighted matrix of an algorithm according to some embodiments of the disclosure. That is, all the elements in FIG. 3A are squared and weighted. The row weighted sums (rSum) and the column weighted sums (cSum) of the matrices are calculated both in FIG. 3A and FIG. 3B.

According to the algorithm in FIG. 3A, after calculations, the obtained number of column prunings is 2, which indicates an action of removing the two columns with the smallest column weighted sums cSum, respectively corresponding to the tokens “movie” and “.”. The pruned result is shown in FIG. 4A.

According to the algorithm in FIG. 3B, i.e., the algorithm provided in the disclosure, the sparsity S₁ may be calculated as 5.628, and the pruning ratio R_{P} is 0.578. Therefore, the number of column prunings is 9*0.578=5, which indicates an action of removing the five columns with the smallest column weighted sum cSum, corresponding to the tokens “,”, “witty”, “,”, “uctive”, and “.”. The pruned result is shown in FIG. 4B.

Therefore, from the results shown in FIG. 3A, FIG. 3B, FIG. 4A, and FIG. 4B, it may be learned that the algorithm provided in the disclosure may be applied to effectively prune the text, thus significantly reducing the computational load of matrix operations.

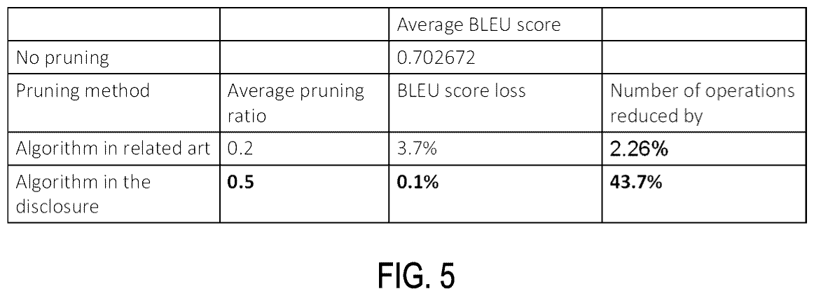

FIG. 5 illustrates a comparison of an algorithm provided in the related art and an algorithm according to some embodiments of the disclosure.

With reference to FIG. 5, the results shown in FIG. 3A, FIG. 3B, FIG. 4A, and FIG. 4B, i.e., the algorithm provided in the related art and the algorithm provided in the disclosure before pruning, are compared in FIG. 5.

The comparison is performed through BiLingual Evaluation Understudy (BLEU). The BLEU scores range from 0 to 1. The higher the BLEU score, the higher the efficiency.

As shown in FIG. 5, given that no pruning operation is performed, operations are performed on “A gorgeous, witty, seductive movie.”, which is equivalent to what is shown in FIG. 1 without performing the operations 116 and 222. The BLEU score at this time is 0.702672.

When calculations are performed on the same text by applying the related art shown in FIG. 3A and FIG. 4A, the average pruning ratio is 0.2. At this time, the BLEU score is reduced by 3.7% as compared to the situation where no pruning operation is performed. Compared to the situation where no pruning operation is performed, the number of the operations is reduced by 2.26%.

When calculations are performed on the same text by applying the algorithm provided in the disclosure as shown in FIG. 3A and FIG. 4A, the average pruning ratio is 0.5. At this time, the BLEU score is reduced by 0.1% as compared to the situation where no pruning operation is performed. Compared to the situation where no pruning operation is performed, the number of the operations is reduced by 43.7%.

Therefore, it may be learned that the algorithm provided in one or more embodiments of the disclosure may achieve a better pruning ratio; that is, more unnecessary tokens may be removed, while the impact on the BLEU score is only one thirty-seventh of the impact on the BLEU score provided in the related art, which means that the results obtained herein are almost the same as the results obtained while no pruning operation is performed, and the number of the reduced operations is increased by more than 40% of the number of the operations while no pruning operation is performed. Therefore, the algorithm provided in one or more embodiments of the disclosure may significantly improve the pruning ratio, reduce the number of operations, and pose minimal impact on the text.

The algorithms provided in one or more embodiments of the disclosure may be applied in various fields.

To meet real-time calculation demands, many modern applications, such as machine translation, voice assistants, or instant messaging tools, require rapid feedback. Therefore, acceleration of the calculations by pruning may significantly enhance the real-time calculation speed.

In consideration of energy efficiency, current large-scale models demand considerable computational resources during both training and inference, which leads to an increase in operating costs and environmental pressure. The algorithms provided in one or more embodiments of the disclosure allow a significant reduction in the energy consumption of the models during calculations.

In consideration of mobile computational needs, as technology advances, an increasing number of calculations are transitioning to edge devices, such as smartphones, drones, or other embedded systems. The devices often have limited computational capabilities and battery life. The algorithms provided in one or more embodiments of the disclosure contribute to a significant reduction of computational demands, thus ensuring smoother and more durable operations of the applications on such devices.

As to needs of advancing research development, the fields of deep learning and natural language processing are evolving rapidly. Researchers are continually required to adjust and optimize models, and slow computational speed often serves as a bottleneck. The algorithms provided in one or more embodiments of the disclosure enable quicker experiments and iterations, thereby accelerating the progress of research.

To sum up, one or more embodiments of the disclosure provides a dynamic pruning strategy which allows dynamic adjustment of the pruning ratio according to the characteristics of the input text to reduce the amount of data involved in the calculations. Compared with the conventional static token pruning algorithms, the algorithms provided herein exhibit higher flexibility and adaptability. Experiments have proven that the algorithms provided herein, even under significant pruning, may maintain model accuracy while reducing computational costs, and the algorithms provided herein outperform the conventional static pruning algorithms in most scenarios.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An algorithm for a sparse attention operation, the algorithm comprising following steps:
calculating, by a processor, an attention probability matrix based on a query matrix and a key matrix stored in a storage device;
calculating, by the processor, a pruning ratio based on the attention probability matrix;
pruning, by the processor, the attention probability matrix based on the pruning ratio to obtain a pruned attention probability matrix;
pruning, by the processor, a value matrix generated by an input text based on the pruning ratio to obtain a pruned value matrix; and
multiplying, by the processor, the pruned attention probability matrix and the pruned value matrix to obtain an attention matrix.

2. The algorithm according to claim 1, wherein the query matrix Q, the key matrix K, and the attention probability matrix O satisfy a following relationship:
$$O = softmax ( \frac{Q {K}^{T}}{\sqrt{{d}_{k}}} ) ,$$
wherein dₖ is the number of columns in the key matrix.

3. The algorithm according to claim 1, wherein the step of calculating the pruning ratio based on the attention probability matrix comprises:
weighting each element of the attention probability matrix to obtain an attention probability weighted matrix;
calculating a sum of the elements in each row of the attention probability weighted matrix to obtain a row weighted sum for each row of the attention probability weighted matrix;
calculating a sum of the elements in each column of the attention probability weighted matrix to obtain a column weighted sum for each column of the attention probability weighted matrix;
accumulating the row weighted sum of each row of the attention probability weighted matrix to obtain attention information of the attention probability weighted matrix; and
determining the pruning ratio based on the attention information.

4. The algorithm according to claim 2, wherein in the step of weighting each element of the attention probability matrix to obtain the attention probability weighted matrix, if a maximum value of the elements in the attention probability matrix is Vmax, a minimum value of the elements in the attention probability matrix is Vmin, a weighted maximum value is Vmax′, and a weighted minimum value is Vmin′, then a following relationship is satisfied:
$$\frac{V max}{V min} \leq \frac{V max ′}{V min ′} .$$

5. The algorithm according to claim 2, wherein the step of weighting each element of the attention probability matrix comprises: weighting each element in a non-linear manner.

6. The algorithm according to claim 2, wherein the step of weighting each element of the attention probability matrix comprises: calculating a square value of each element.

7. The algorithm according to claim 2, wherein the step of determining the pruning ratio based on the attention information comprises: normalizing the attention information within a range to obtain the pruning ratio.

8. The algorithm according to claim 7, wherein the step of normalizing the attention information comprises: normalizing the attention information in a linear manner or in a non-linear manner.

9. The algorithm according to claim 2, wherein the pruning ratio is expressed by a following formula:
$${R}_{P} = α \frac{{s}_{I - 1}}{n - 1} ,$$
wherein, R_{P} is the pruning ratio, α is a given parameter, S₁ is an attention parameter, and n is the number of tokens in the attention probability matrix.

10. The algorithm according to claim 1, wherein the step of pruning the attention probability matrix based on the pruning ratio comprises:
calculating the number of column prunings based on the pruning ratio and the number of columns in the attention probability matrix,
arranging the column weighted sum of each column of the attention probability matrix in an ascending order, sequentially pruning the columns corresponding to the column weighted sums until the number of pruned columns equals the number of the column prunings, wherein the step of pruning the columns of the attention probability matrix comprises: setting values of all the elements in the columns to 0.

11. An algorithm for a sparse attention operation, the algorithm comprising following steps:
pruning, by a processor, a query matrix stored in a storage device based on a first pruning ratio stored in the storage device to obtain a pruned query matrix, wherein the first pruning ratio is a pruning ratio of a previous pruned layer;
pruning, by the processor, a key matrix stored in the storage device based on the first pruning ratio to obtain a pruned key matrix;
calculating, by the processor, an attention probability matrix based on the pruned query matrix and the pruned key matrix;
calculating, by the processor, a second pruning ratio based on the attention probability matrix;
pruning, by the processor, the attention probability matrix based on the second pruning ratio to obtain a pruned attention probability matrix;
pruning, by the processor, a value matrix generated by the input text based on the second pruning ratio to obtain a pruned value matrix;
multiplying, by the processor, the pruned attention probability matrix and the pruned value matrix to obtain an attention matrix.

12. The algorithm according to claim 11, wherein the pruned query matrix Q′, the pruned key matrix K′, and the pruned attention probability matrix O′ satisfy a relationship:
$$O = softmax ( \frac{Q ′ K {′}^{T}}{\sqrt{{d}_{k}}} ) ,$$
wherein dₖ is the number of columns in the key matrix.

13. The algorithm according to claim 11, wherein the step of calculating the pruning ratio based on the attention probability matrix comprises:
weighting each element of the attention probability matrix to obtain an attention probability weighted matrix;
calculating a sum of the elements in each row of the attention probability weighted matrix to obtain a row weighted sum for each row of the attention probability weighted matrix;
calculating a sum of the elements in each column of the attention probability weighted matrix to obtain a column weighted sum for each column of the attention probability weighted matrix;
accumulating the row weighted sum of each row of the attention probability weighted matrix to obtain attention information of the attention probability weighted matrix; and
determining the second pruning ratio based on the attention information.

14. The algorithm according to claim 12, wherein in the step of weighting each element of the attention probability matrix to obtain the attention probability weighted matrix, if a maximum value of the elements in the attention probability matrix is Vmax, a minimum value of the elements in the attention probability matrix is Vmin, a weighted maximum value is Vmax′, and a weighted minimum value is Vmin′, then a following relationship is satisfied:
$$\frac{V max}{V min} \leq \frac{V max ′}{V min ′} .$$

15. The algorithm according to claim 12, wherein the step of weighting each element of the attention probability matrix comprises: weighting each element in a non-linear manner.

16. The algorithm according to claim 12, wherein the step of weighting each element of the attention probability matrix comprises: calculating a square value of each element.

17. The algorithm according to claim 12, wherein the step of determining the pruning ratio based on the attention information comprises: normalizing the attention information within a range to obtain the pruning ratio.

18. The algorithm according to claim 17, wherein the step of normalizing the attention information comprises: normalizing the attention information in a linear manner or in a non-linear manner.

19. The algorithm according to claim 12, wherein the pruning ratio is expressed by a following formula:
$${R}_{P} = α \frac{{s}_{I - 1}}{n - 1} ,$$
wherein, R_{P} is the pruning ratio, α is a given parameter, S₁ is an attention parameter, and n is the number of tokens in the attention probability matrix.

20. The algorithm according to claim 11, wherein the step of pruning the attention probability matrix based on the pruning ratio comprises:
calculating the number of column prunings based on the pruning ratio and the number of columns in the attention probability matrix,
arranging the column weighted sum of each column of the attention probability matrix in an ascending order, sequentially pruning the columns corresponding to the column weighted sums until the number of pruned columns equals the number of the column prunings, wherein the step of pruning the columns of the attention probability matrix comprises: setting values of all the elements in the columns to 0.
